(19) United States
(12) Patent Application Publication
(10) Pub. No.: US 2026/0094362 A1
(43) Pub. Date: Apr. 2, 2026

(54) Artificial Intelligence (AI) Generated Three-Dimensional (3D) Images

(71) Applicant: Austin Zurfluh, Spokane, WA (US)

(72) Inventor: Austin Zurfluh, Spokane, WA (US)

(21) Appl. No.: 18/902,683

(22) Filed: Sep. 30, 2024

(51) Int. Cl. G06T 17/00

(52) U.S. Cl. CPC G06T 17/00

(57) ABSTRACT

Systems and methods for three-dimensional 3D model generation are disclosed. An artificial intelligence (AI) image may represent a work of art that a user desires to be used in the generation of a physical object representing that work of art. An AI model may be trained and utilized to create artwork representing physical object using input from the user. Once an AI image is created, the AI image may be converted to a 3D model including a 3D printable format and used to generate a physical object representing the character via a 3D printer.

### BACKGROUND

Three-dimensional (3D) printing may be used to generate physical objects based on 3D images configured in a 3D printable format. Images obtained from artificial intelligence (AI) sources are typically in 2D format and are not generated in a format usable by a 3D printing system to create a physical objection representing the AI based image. For instance, the AI based image may include background content as well as varying levels of detail that reduce the accuracy and quality with which a corresponding 3D image can be generated. Described herein are improvements in technology and solutions to technical problems that can be used to, among other things, assist in the generation of accurate 3D images used to generate physical objects.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a schematic diagram of an example architecture for generating 3D models based on 2D images obtained from generative AI.

FIG. 2 illustrates an example user interface displaying AI artifact generation functionality in accordance with a marketplace system.

FIG. 3 illustrates an example process for removing a background from an AI generated image, in accordance with a marketplace system.

FIG. 4A illustrates an example process for dividing an image subject into two portions, in accordance with a marketplace system.

FIG. 4B illustrates an example process for combining two 3D models to generate a single 3D model, in accordance with a marketplace system.

FIG. 5 illustrates a process for generating a 3D model in accordance with a marketplace system.

FIG. 6 illustrates a process for generating a 3D model in accordance with a marketplace system.

### DETAILED DESCRIPTION

Systems and methods for generating a 3D image based on an AI created image that can be used to create a physical object representing the AI created image are discussed herein. In some examples, an AI created image may represent a work of art that a user desires to be used in the generation of a physical object representing that work of art. For example, tabletop role-playing game (TTRPG or TRPG), also known as a pen-and-paper role-playing game, is a classification for a role-playing game (RPG) in which the participants describe their characters'actions through speech, and sometimes movements. In these games, it is common to have a physical representation of each character during the game (e.g., an action figure, statue, character miniatures, etc.). With the prevalence of AI, it is possible to train and utilize AI models to create artwork representing these characters using minimal input from the user and generating intricately detailed and creative works of art. Once an AI image is created, it is possible to convert the AI image to a 3D image and use the 3D image in a 3D printable format (e.g., .STL) to generate a physical object representing the character via a 3D printer. It is understood that the process discussed herein for generating a 3D image from an AI based image is not limited to gaming characters but may be used for any 2D image that a user desires to generate a corresponding 3D image.

In some cases, a system may enable users to select from one or more “artist models,” which may include generative AI image generation models trained on art from one particular artist. This may enable users to maintain a consistent style among images and physical objects (e.g., character miniatures) they intend to generate. In some cases, the artis model may include a Dynamic Search-Free Low-Rank Adaptation (dyLoRA) model. With the ever-growing size of pretrained models (PMs), fine-tuning them has become more expensive and resource-hungry. As a remedy, low-rank adapters (LoRA) keep the main pretrained weights of the model frozen and just introduce some learnable truncated SVD modules (so-called LoRA blocks) to the model. While LoRA blocks are parameter-efficient, they suffer from two major problems: first, the size of these blocks is fixed and cannot be modified after training (for example, if we need to change the rank of LoRA blocks, then we need to re-train them from scratch); second, optimizing their rank requires an exhaustive search and effort. DyLoRA techniques address these two problems together. DyLoRA techniques train LoRA blocks for a range of ranks instead of a single rank by sorting the representation learned by the adapter module at different ranks during training. A solution is evaluated on different natural language understanding (GLUE benchmark) and language generation tasks (E2E, DART and WebNLG) using different pretrained models such as RoBERTa and GPT with different sizes. Results show that dynamic search-free models can be trained with DyLoRA at least 4 to 7 times (depending to the task) faster than LoRA without significantly compromising performance.

In some cases, the system may be configured to compensate artists in response to users selecting the artists respective artist model. For example, the system may store payment information associated with each artist (e.g., bank account numbers, payment application information, etc.) and in response to receiving a selection of an artist model (e.g., artist style), the system my forward payment to the selected artist (e.g., pay artists $0.01 USD per image generated with their artis model).

In some cases, the system may be configured to generate an image including an image subject using a custom trained AI image model (e.g., via the model training technique dyLoRA) to generate full image subjects without any backgrounds and in the style of the artist model chosen by the user. For example, the custom trained AI image model may be trained by providing images (e.g., 50 images, 60 images, 70 images, etc.) to the custom trained AI image model with the backgrounds removed from each of those images and replaced with a white background. This enables the system to receive input requests from a user for generating an AI based artifact (e.g., an image of a character) and to generate the AI based artifact both in the style of the artist and also without a background. Generating images with no background improves the quality of the 3D image output as well as reduces the computing power required when formatting the AI image to a 3D image because there are less color pixels to for the 3D image generator to process.

In some examples, the system may remove pixel space around the image subject, so that the image subject is as large as possible in the image. For example, the system may identify one or more pixels surrounding the image subject and remove the pixel space in which these pixels are located. Removing these pixels and/or the pixel space increases the percentage of area in which the image subject is presented in the image. Removing the unnecessary pixels and/or pixels spaces improves the quality of the 3D image output as well as reduces the computing power required when formatting the AI image to a 3D image because there are less pixels to for the 3D image generator to process.

In some examples, the system may divide the AI image into two separate images. For example, the system may identify a vertical midline and/or a horizontal midline depending on a context of the AI image. By way of example, an AI image of a dog may be divided via a vertical midline such that the head and front legs of the dog are included in a first image on the left, and the hind legs and tail are included in a second image on the right. Using two different 2D images results in an improved 3D model output because the context of the 2D images are more readily understandable by the 3D model generator (as opposed to if the image was sliced via a horizontal midline and a first image included 4 legs and a stomach and the second image include a tail, a head, and top half of the dog). In some cases, the system may automatically determine a direction to generate a midline (e.g., horizontal, vertical, diagonal, etc.) as well as a placement of the midline (e.g., dividing the image exactly in half 50% on top or left and 50% on bottom or right). For instance, the system may dynamically determine a placement of the midline such that the 3D model generator may generate a 3D model output of the image subject in a highest quality and most efficient manner based on an anatomy of the image subject in question. For instance, the system may identify hands and/or fingers of the image subject and place a midline over the 2D image to avoid slicing directly over the hands and/or fingers of the image subject, as these can be difficult both for a human or machine to understand what that image represents, in the output of one of the individual images (e.g., a single finger or hand that is unattached to a body and is “floating” in the image).

In some cases, once the AI image (also referred to as the 2D image) has been generated and divided the system may generate a 3D model for each image slice. For instance, by way of example, if the AI image was divided via a vertical midline, the system may generate a first 3D model for a first image representing the left side and a second 3D model for a second image representing the right side.

In some examples, the system may combine the 3D models (e.g., the first 3D model and the second 3D model) and generate a combined 3D model representing the AI image (e.g., the image subject of the 2D image). The 3D model may be generated in a 3D printable format, such as .STL. In some cases, the 3D model may be post-processed and fine-tuned for quality purposes. In some examples, the system may send the 3D model to a third-party 3D printer for printing, painting, and/or fulfillment.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

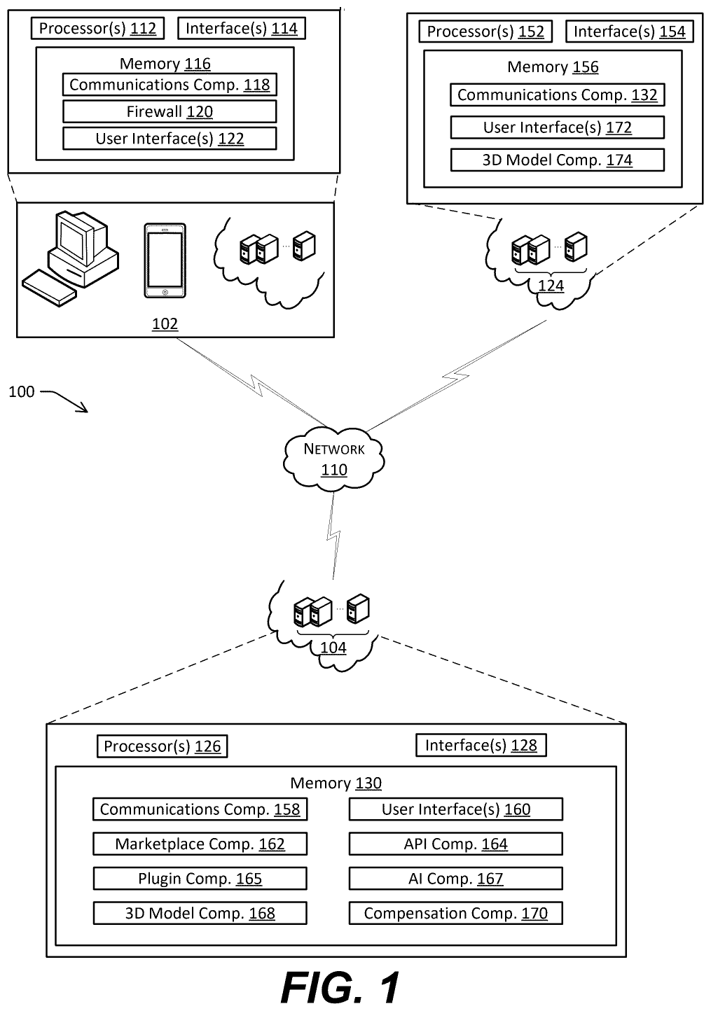

FIG. 1 illustrates a schematic diagram of an example architecture 100 for generating 3D models based on 2D images obtained from generative AI. The architecture 100 may include, for example, one or more client-side devices, also described herein as electronic devices 102, that allow clients to access a marketplace and provide user input. In some examples, the electronic devices 102 may be associated with a user that desires to create a physical object (e.g., a physical character representative of a character in gaming) using 3D printing. The architecture 100 includes a marketplace system 104 that is remote from, but in communication with, the client-side electronic devices. The architecture 100 also has a third-party marketplace system 124 that is remote from, but in communication with, the client-side devices 102 and the marketplace system 104. The marketplace system 104 may be used to perform generation of artifacts (e.g., AI artifacts, 2D images, etc.) and transactions involving artifacts and/or information associated with artifacts. The marketplace system 104 may also be used to generate 3D models based on AI artifacts and/or 2D images. The architecture 100 also has a third-party printing service (e.g., 3D printing service) capable of receiving 3D models in a 3D printable format (e.g., .STL) and printing physical objects based on the 3D models. Some or all of the devices and systems may be configured to communicate with each other via a network 110. The architecture 100 also has a third-party printing service (e.g., 3D printing service) capable of receiving 3D models in a 3D printable format (e.g., .STL) and printing physical objects based on the 3D models.

The electronic devices 102 may include components such as, for example, one or more processors 112, one or more network interfaces 114, and/or memory 116. The memory 116 may include components such as, for example, a communications component 118, a firewall 120, and/or one or more user interfaces 122. As shown in FIG. 1, the electronic devices 102 may include, for example, a computing device, a mobile phone, a tablet, a laptop, and/or one or more servers. The components of the electronic device 102 will be described below by way of example. It should be understood that the example provided herein is illustrative, and should not be considered the exclusive example of the components of the electronic device 102.

By way of example, the user interface(s) 122 may include a selectable portion that, when selected, may enable a user to provide user input, such as a prompt to be used when generation an AI artifact. For example, the user input may include text describing an image representing a character from a game (e.g., facial features, character sex, clothing, etc.). In some cases, the user input may include a selection of a particular artists style to be used when generating the image. For example, the user interface 122 may present multiple versions of an image subject each depicting the image subject in an artist version associated with each individual artist. In some cases, the user interface 122 may enable the user to select which of the versions (e.g., which artist model) the user desires to be used when generating the image.

The communications component 118 may be configured to enable communications between the electronic device 102 and the other components of the architecture 100, such as the marketplace system 104, and/or the third-party marketplace system 124. The communications component 118 may further generate data to be communicated and/or may format already-generated data for transfer to one or more of the remote systems. The communications component 118 may also be configured to receive data from one or more of the remote systems.

The firewall 120 may be configured to receive data from the communications component 118 and/or from one or more other components of the electronic device 102. The firewall 120 may be described as a network security system that may monitor and/or control incoming and outgoing data based on security rules. The security rules may indicate that the electronic device 102 is configured to send certain data to the marketplace system 104, and/or the third-party marketplace system 124. The security rules may also indicate that the electronic device 102 is configured to receive certain data from the marketplace system 104, and/or the third-party marketplace system 124.

The marketplace system 104 may include components such as, for example, one or more processors 126, one or more network interfaces 128, and memory 130. The memory 130 may include components such as, for example, a communications component 158, one or more user interfaces 160, a marketplace component 162, an application programming interface (API) component 164, a plugin component 165, an artificial intelligence (AI) component 167, a 3D model component 168, and/or a compensation component 170. The components of the marketplace system 104 will be described below by way of example. It should be understood that the example provided herein is illustrative, and should not be considered the exclusive example of the components of the marketplace system 104. The communications component 158 and the user interfaces 160 may include the same or similar functionality as the communications component 118 and the user interfaces 122 of the electronic device 102 and be used to communicate with and interface with the electronic device 102, and/or the third-party marketplace system 124.

The marketplace component 162 may be configured to enable users to request AI artifacts (e.g., artwork, character images, etc.). For example, tabletop role-playing game (TTRPG or TRPG), also known as a pen-and-paper role-playing game, is a classification for a role-playing game (RPG) in which the participants describe their characters'actions through speech, and sometimes movements. In these games, it is common to have a physical representation of each character during the game (e.g., an action figure, statue, character miniatures, etc.). The marketplace competent 162 may be configures to utilize AI models to receive user input describing these characters and create artwork representing these characters and generating intricately detailed and creative works of art.

The API component 164 may be configured to enable users of the marketplace system 104 to interact with services provided by the marketplace system 104. For example, a purchasing entity accessing the marketplace component 162 to purchase an item, such as, an AI artifact, may desire to provide user input and/or select an art model in which to stylize the AI artifact. The marketplace system 104 may present the API component 164 such that the purchasing entity may interact with the marketplace system 104 in order to provide the user input and view selectable options.

In some examples, the AI component 167 may be configured to enable entities to generate AI artifacts. For example, marketplace system 104 may include and/or otherwise be associated with a generative AI model capable, via the AI component 167, of receiving prompts from a user in order to generate an AI artifact. In some cases, the AI component 167 may uses models trained on a large data set of content medium (text, images, audio, video) to create a new generative AI artifact. In some cases, the AI component 167 may enable users to select from one or more “artist models,” which may include generative AI image generation models trained on art from one particular artist. This may enable users to maintain a consistent style among images and physical objects (e.g., character miniatures) they intend to generate. In some cases, the artis model may include a Dynamic Search-Free Low-Rank Adaptation (dyLoRA) model. DyLoRA techniques train LoRA blocks for a range of ranks instead of a single rank by sorting the representation learned by the adapter module at different ranks during training. A solution is evaluated on different natural language understanding (GLUE benchmark) and language generation tasks (E2E, DART and WebNLG) using different pretrained models such as RoBERTa and GPT with different sizes. Results show that dynamic search-free models can be trained with DyLoRA at least 4 to 7 times (depending to the task) faster than LoRA without significantly compromising performance.

In some cases, the AI component 167 may include a custom trained AI model and may be configured to generate an image including an image subject without any backgrounds and in the style of the artist model chosen by the user. For example, the custom trained AI image model may be trained by providing images (e.g., 50 images, 60 images, 70 images, etc.) to the custom trained AI image model with the backgrounds removed from each of those images and replaced with a white background. This enables the AI component 167 to receive input requests from a user for generating an AI based artifact (e.g., an image of a character) and to generate the AI based artifact both in the style of the artist and also without a background. Generating images with no background improves the quality of the 3D image output as well as reduces the computing power required when formatting the AI image to a 3D image because there are less color pixels to for the 3D image generator to process.

In some examples, the AI component 167 may remove pixel space around the image subject, so that the image subject is as large as possible in the image. For example, the AI component 167 may identify one or more pixels surrounding the image subject and remove the pixel space in which these pixels are located. Removing these pixels and/or the pixel space increases the percentage of area in which the image subject is presented in the image. Removing the unnecessary pixels and/or pixels spaces improves the quality of the 3D image output as well as reduces the computing power required when formatting the AI image to a 3D image because there are less pixels to for the 3D image generator to process.

In some cases, the 3D modeling component 168 may be configured to generate a 3D model (e.g., a 3D image usable by a 3D printer to generate a physical object) based on the AI image (e.g., the 2D image obtained from the AI component 167). For, example, the 3D modeling component 168 may divide the AI image into two separate images. In some cases, the 3D modeling component 168 may identify a vertical midline and/or a horizontal midline depending on a context of the AI image. By way of example, an AI image of a dog may be divided via a vertical midline such that the head and front legs of the dog are included in a first image on the left, and the hind legs and tail are included in a second image on the right. Using two different 2D images results in an improved 3D model output because the context of the 2D images are more readily understandable by the 3D modeling component 168, which may include a 3D model generator, (as opposed to if the image was sliced via a horizontal midline and a first image included 4 legs and a stomach and the second image include a tail, a head, and top half of the dog). In some cases, the 3D modeling component 168 may automatically determine a direction to generate a midline (e.g., horizontal, vertical, diagonal, etc.) as well as a placement of the midline (e.g., dividing the image exactly in half 50% on top or left and 50% on bottom or right). For instance, the 3D modeling component 168 may dynamically determine a placement of the midline such that the 3D modeling component 168 may generate a 3D model output of the image subject in a highest quality and most efficient manner based on an anatomy of the image subject in question. For instance, the 3D modeling component 168 may identify hands and/or fingers of the image subject and place a midline over the 2D image to avoid slicing directly over the hands and/or fingers of the image subject, as these can be difficult both for a human or machine to understand what that image represents, in the output of one of the individual images (e.g., a single finger or hand that is unattached to a body and is “floating” in the image).

In some cases, once the AI image (also referred to as the 2D image) has been generated and divided, the 3D modeling component 168 may generate a 3D model for each image slice. For instance, by way of example, if the AI image was divided via a vertical midline, the 3D modeling component 168 may generate a first 3D model for a first image representing the left side and a second 3D model for a second image representing the right side.

In some examples, the 3D modeling component 168 may combine the 3D models (e.g., the first 3D model and the second 3D model) and generate a combined 3D model representing the AI image (e.g., the image subject of the 2D image). The 3D model may be generated in a 3D printable format, such as .STL. In some cases, the 3D model may be post-processed and fine-tuned for quality purposes. In some examples, the 3D modeling component 168 may send the 3D model to third-party marketplace system 124 (which may include a 3D printing marketplace) for printing, painting, and/or fulfillment.

In some cases, the compensation component 170 may be configured to configured to compensate artists in response to users selecting the artists respective artist model. For example, the compensation component 170 may store payment information associated with each artist (e.g., bank account numbers, payment application information, etc.) and in response to receiving a selection of an artist model (e.g., artist style), the compensation component 170 my forward payment to the selected artist (e.g., pay artists $0.01 USD per image generated with their artis model).

The third-party marketplace system 124 may include components such as, for example, one or more processors 152, one or more network interfaces 154, and memory 130. The memory 130 may include components such as, for example, communications component 132, user interfaces 172, and a 3D model component 174. The components of the third-party marketplace system 124 will be described below by way of continued example. It should be understood that the example provided herein is illustrative, and should not be considered the exclusive example of the components of the third-party marketplace system 124. It should be understood that when a system and/or device is described herein as a “remote system” and/or a “remote device,” the system and/or device may be situated in a location that differs from, for example, the electronic device 102.

The communications component 132 may be configured to enable communications between the third-party marketplace system 124 and the other components of the architecture 100, such as the electronic device 102 and the marketplace system 104. The communications component 132 may further generate data to be communicated and/or may format already-generated data for transfer to other components of the architecture 100. The communications component 132 may also be configured to receive data from one or more of the other remote systems and/or the electronic device 102.

It should be noted that the exchange of data and/or information as described herein may be performed only in situations where a user has provided consent for the exchange of such information. For example, a user may be provided with the opportunity to opt in and/or opt out of data exchanges between devices and/or with the remote systems and/or for performance of the functionalities described herein. Additionally, when one of the devices is associated with a first user account and another of the devices is associated with a second user account, user consent may be obtained before performing some, any, or all of the operations and/or processes described herein.

As used herein, a processor, such as processor(s) 112, 152, and/or 126, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 112, 152, and/or 126 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 112, 152, and/or 126 may possess its own local memory, which also may store program components, program data, and/or one or more operating systems.

The memory 116, 156, and/or 130 may include volatile and nonvolatile memory, removable and non-removable media implemented in any method or technology for storage of information, such as non-transitory computer-readable instructions, data structures, program component, or other data. Such memory 116, 156, and/or 130 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 116, 156, and/or 130 may be implemented as computer-readable storage media (“CRSM”), which may be any available physical media accessible by the processor(s) 112, 152, and/or 126 to execute instructions stored on the memory 116, 156, and/or 130. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 116, 156, and/or 130, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Washington, USA; the Windows operating system from Microsoft Corporation of Redmond, Washington, USA; LynxOS as promulgated by Lynx Software Technologies, Inc. of San Jose, California; Operating System Embedded (Enea OSE) as promulgated by ENEA AB of Sweden; and so forth.

The network interface(s) 114, 154 and/or 128 may enable messages between the components and/or devices shown in architecture 100 and/or with one or more other remote systems, as well as other networked devices. Such network interface(s) 114, 154 and/or 128 may include one or more network interface controllers (NICs) or other types of transceiver devices to send and receive messages over the network 110.

For instance, each of the network interface(s) 114, 154 and/or 128 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 114 and/or 128 may include a wide area network (WAN) component to enable message over a wide area network.

In some instances, the marketplace system 104 may be local to an environment associated the electronic device 102. For instance, the marketplace system 104 may be located within the electronic device 102. In some instances, some or all of the functionality of the marketplace system 104 may be performed by the electronic device 102. Also, while various components of the marketplace system 104 have been labeled and named in this disclosure and each component has been described as being configured to cause the processor(s) to perform certain operations, it should be understood that the described operations may be performed by some or all of the components and/or other components not specifically illustrated.

In some cases, any or all of the steps performed by the marketplace system 104 and the associated components may be done so using one or more machine learning models and/or by training one or more machine learning models. For example the communications component 158, the one or more user interfaces 160, the marketplace component 162, the application programming interface (API) component 164, the plugin component 165, the artificial intelligence (AI) component 167, the 3D model component 168, and/or the compensation component 170 may utilize one or more machine learning models and/or by train one or more machine learning models to perform the respective operations discussed herein. As described herein, machine learned models may be generated using various machine learning techniques. For example, the models may be generated using one or more neural network(s). A neural network may be a biologically inspired algorithm or technique which passes input data through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from data. In some cases, the neural network may be a trained network architecture that is end-to-end. In one example, the machine learned models may include segmenting and/or classifying extracted deep convolutional features of data into semantic data. In some cases, appropriate truth outputs of the model in the form of semantic per-pixel classifications.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, ResNeXt101, VGG, DenseNet, PointNet, CenterNet and the like. In some cases, the system may also apply Gaussian blurs, Bayes Functions, color analyzing or processing techniques and/or a combination thereof.

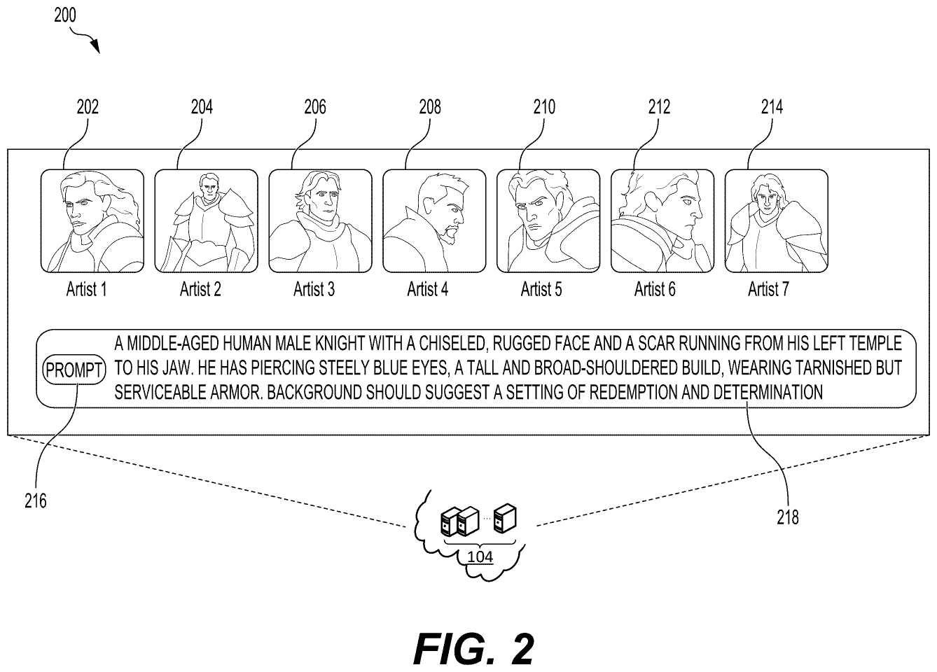

FIG. 2 illustrates an example user interface 200 displaying AI artifact generation functionality in accordance with a marketplace system. The user interface 200 may be displayed on a display of an electronic device, such as the electronic device 102 as described with respect to FIG. 1. The user interface 200 may be the same as or similar to the user interface(s) 122 as described with respect to FIG. 1.

For example, the user interface 200 may be presented to a user and may enable users to select from one or more of the artist model 202, artist model 204, artist model 206, artist model 208, artist model 210, artist model 212, and artist model 214, which may include generative AI image generation models trained on art from one particular artist. For instance, underneath each of the artist model 202, artist model 204, artist model 206, artist model 208, artist model 210, artist model 212, and artist model 214 may be an artist identifier, such as “Artist A,” “Artist B,” “Artist C,” “Artist D,” “Artist E,” “Artist F,” “Artist G.” This may enable users to maintain a consistent style among images and physical objects (e.g., character miniatures) they intend to generate. In some case, the user interface 200 may include a selectable portion 216 that, when selected, may enable a user to provide user input via a text box 218, such as a prompt to be used when generation an AI artifact. For example, the user input may include text describing an image representing a character from a game (e.g., facial features, character sex, clothing, etc.). In some cases, the user input may include a selection of a particular artists style to be used when generating the image. For example, as illustrated in the user interface 200, multiple versions of an image subject each depicting the image subject in an artist version associated with each individual artist.

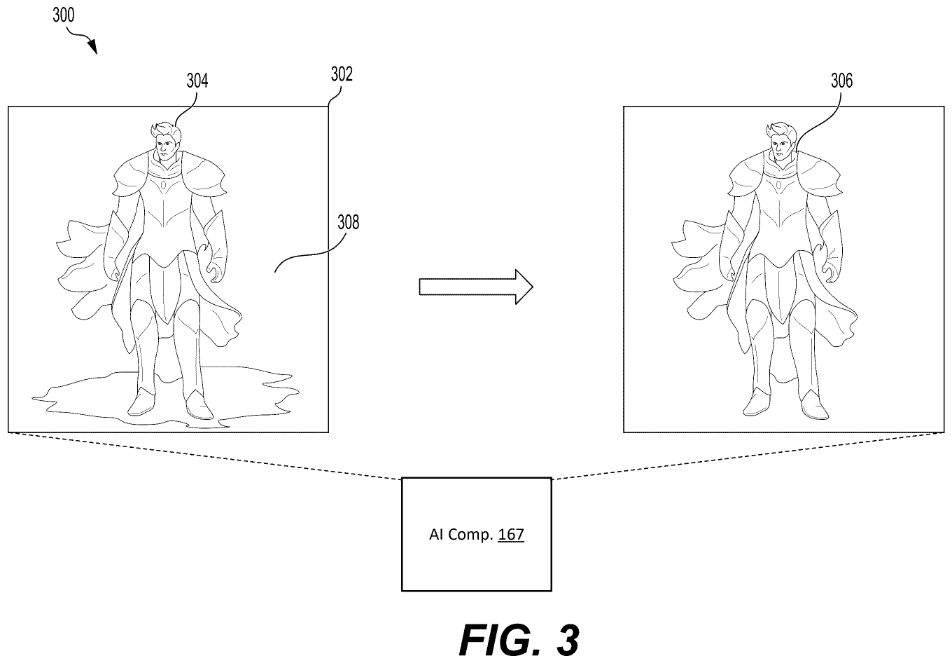

FIG. 3 illustrates an example process 300 for removing a background from an AI generated image, in accordance with a marketplace system. For example, the AI component 167 may be configured to generate an image 302 including an image subject 304 via the AI component 167 to generate image subject 306 with the background 308 of the image 302 removed. In some cases, the image subject 306 may be in the style of the artist model chosen by the user. This enables the AI component 167 to receive input requests from a user for generating the image 302 (e.g., an image of a character) and to generate the image subject 306 both in the style of the artist and also without the background 308. Generating images with no background improves the quality of the 3D image output as well as reduces the computing power required when formatting the AI image to a 3D image because there are less color pixels to for the 3D image generator to process.

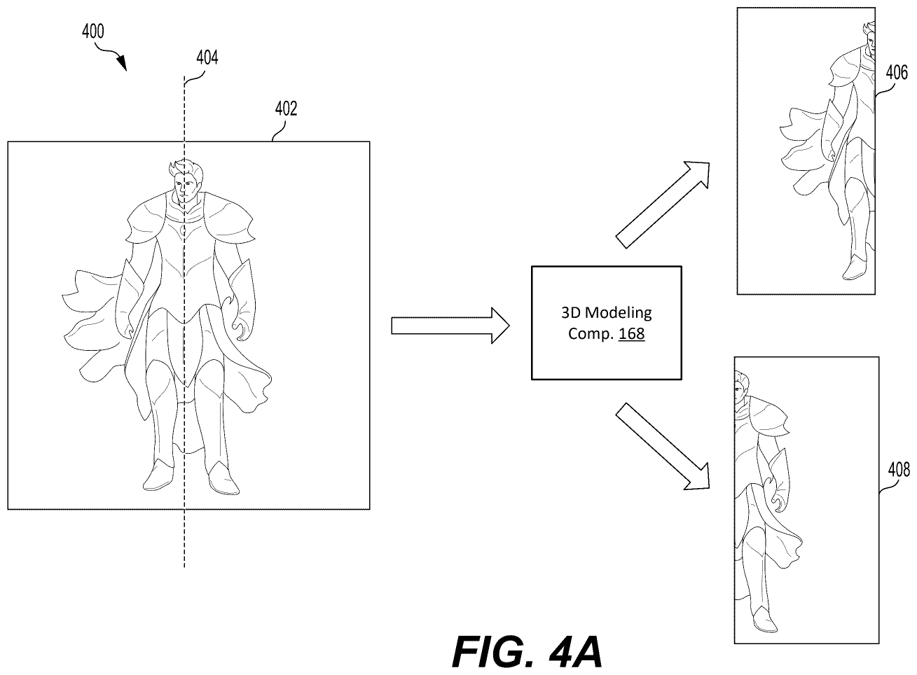

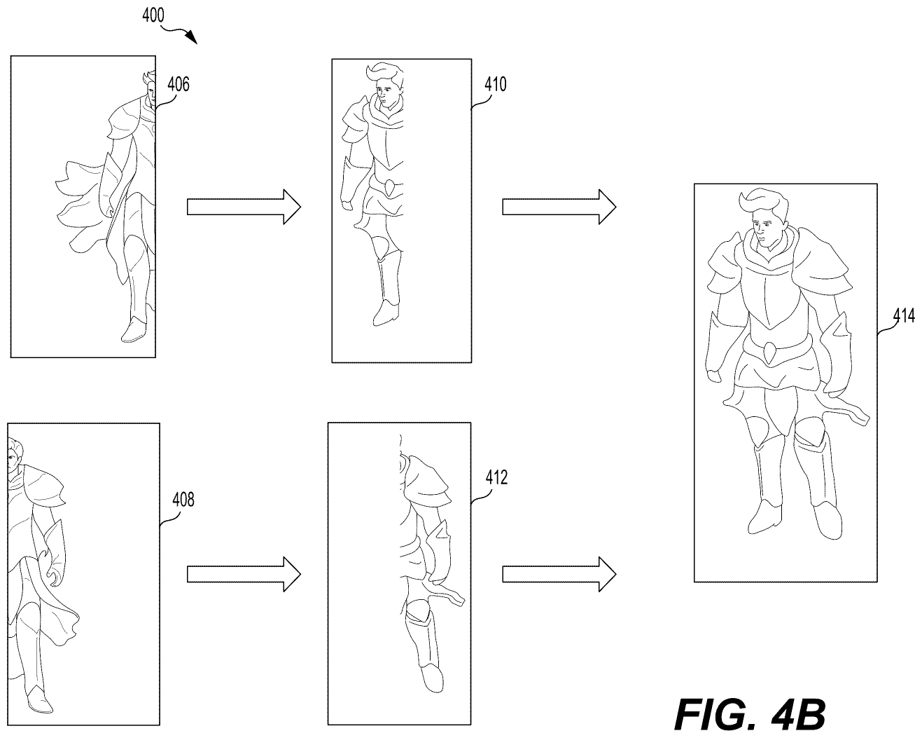

FIG. 4A illustrates an example process 400 for dividing an image subject 402 into two portions, in accordance with a marketplace system. For, example, the 3D modeling component 168 may divide the image subject 402 into two separate images. In some cases, the 3D modeling component 168 may identify a vertical midline 404 depending on a context of the image subject 402. By way of example, the 3D modeling component 168 may identify hands and/or fingers of the image subject 402 and place the vertical midline 404 over the image subject 402 to avoid slicing directly over the hands and/or fingers of the image subject 402, as these can be difficult both for a human or machine to understand what that image represents, in the output of one of the individual images (e.g., a single finger or hand that is unattached to a body and is “floating” in the image). Generating the a slice 406 and a slice 408 results in an improved 3D model output because the context of the 2D images are more readily understandable by the 3D modeling component 168, which may include a 3D model generator, (as opposed to if the image was sliced via a horizontal midline and a first image included 4 legs and a stomach and the second image include a tail, a head, and top half of the dog). In some cases, the 3D modeling component 168 may automatically determine a direction to generate a midline (e.g., horizontal, vertical, diagonal, etc.) as well as a placement of the midline (e.g., dividing the image exactly in half 50% on top or left and 50% on bottom or right). For instance, the 3D modeling component 168 may dynamically determine a placement of the midline such that the 3D modeling component 168 may generate a 3D model output of the image subject in a highest quality and most efficient manner based on an anatomy of the image subject in question.

FIG. 4B illustrates an example process for combining two 3D models to generate a single 3D model, in accordance with a marketplace system. For example, once the image subject 402 (also referred to as the AI image or the 2D image) has been generated and divided into the slice 406 and the slice 408, the 3D modeling component 168 may generate a 3D model 410 representing the slice 406 and a 3D model 412 representing the slice 408. In some examples, the 3D modeling component 168 may combine the 3D model 410 and the 3D model 412 and generate a combined 3D model 414 representing subject 402 (e.g., the image subject of the AI image and/or the 2D image). The 3D model 414 may be generated in a 3D printable format, such as .STL. In some cases, the 3D model 414 may be post-processed and fine-tuned for quality purposes. In some examples, the 3D modeling component 168 may send the 3D model 414 to third-party marketplace system 124 (which may include a 3D printing marketplace) for printing, painting, and/or fulfillment.

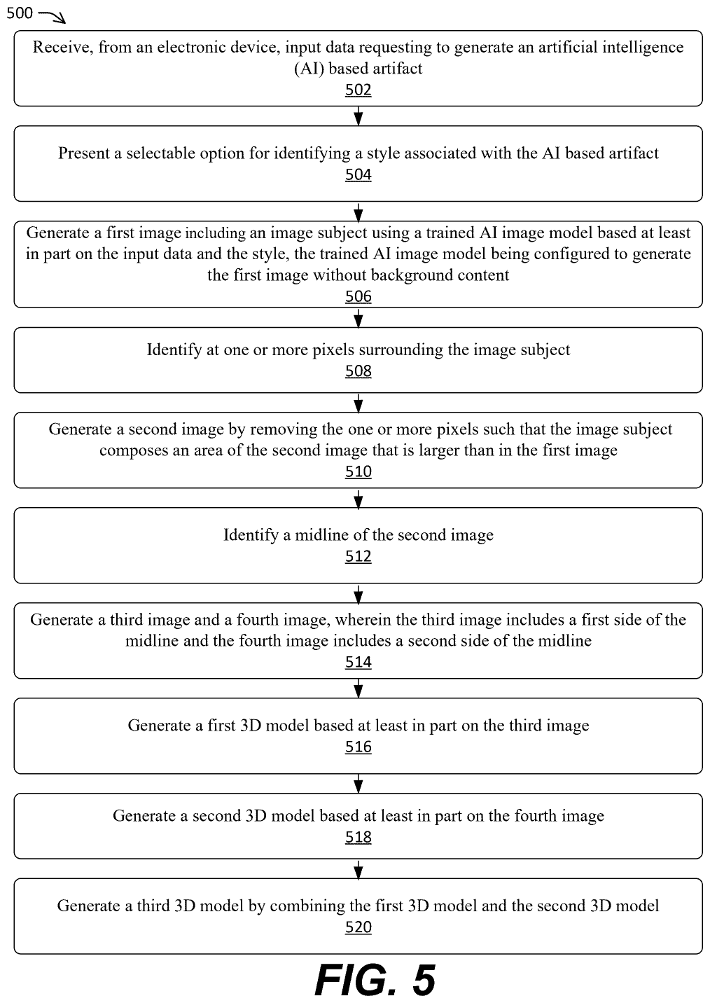

FIG. 5 illustrates a process 500 for generating a 3D model. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIG. 5, although the processes may be implemented in a wide variety of other environments, architectures and systems.

FIG. 5 illustrates a flow diagram of an example process 500 for generating a 3D model. The process 500 may be implemented by the market system, 104, the electronic device, and/or a combination thereof.

At block 502, the process 500 may include receiving, from an electronic device, input data requesting to generate an artificial intelligence (AI) based artifact. For example, the user input may include text describing an image representing a character from a game (e.g., facial features, character sex, clothing, etc.).

At block 504, the process 500 may include presenting a selectable option for identifying a style associated with the AI based artifact. For example, the user interface 200 may be presented to a user and may enable users to select from one or more of the artist model 202, artist model 204, artist model 206, artist model 208, artist model 210, artist model 212, and artist model 214, which may include generative AI image generation models trained on art from one particular artist. For instance, underneath each of the artist model 202, artist model 204, artist model 206, artist model 208, artist model 210, artist model 212, and artist model 214 may be an artist identifier, such as “Artist A,” “Artist B,” “Artist C,” “Artist D,” “Artist E,” “Artist F,” “Artist G.” This may enable users to maintain a consistent style among images and physical objects (e.g., character miniatures) they intend to generate. In some case, the user interface 200 may include a selectable portion 216 that, when selected, may enable a user to provide user input via a text box 218, such as a prompt to be used when generation an AI artifact. For example, the user input may include text describing an image representing a character from a game (e.g., facial features, character sex, clothing, etc.). In some cases, the user input may include a selection of a particular artists style to be used when generating the image. For example, as illustrated in the user interface 200, multiple versions of an image subject each depicting the image subject in an artist version associated with each individual artist.

At block 506, the process 500 may include generating a first image including an image subject using a trained AI image model based at least in part on the input data and the style, the trained AI image model being configured to generate the first image without background content. For example, the AI component 167 may be configured to generate an image 302 including an image subject 304 via the AI component 167 to generate image subject 306 with the background 308 of the image 302 removed. In some cases, the image subject 306 may be in the style of the artist model chosen by the user. This enables the AI component 167 to receive input requests from a user for generating the image 302 (e.g., an image of a character) and to generate the image subject 306 both in the style of the artist and also without the background 308. Generating images with no background improves the quality of the 3D image output as well as reduces the computing power required when formatting the AI image to a 3D image because there are less color pixels to for the 3D image generator to process.

At block 508, the process 500 may include identifying at one or more pixels surrounding the image subject and at block 510, the process 500 may include generating a second image by removing the one or more pixels such that the image subject composes an area of the second image that is larger than in the first image. For example, the AI component 167 may remove pixel space around the image subject, so that the image subject is as large as possible in the image. For example, the AI component 167 may identify one or more pixels surrounding the image subject and remove the pixel space in which these pixels are located. Removing these pixels and/or the pixel space increases the percentage of area in which the image subject is presented in the image. Removing the unnecessary pixels and/or pixels spaces improves the quality of the 3D image output as well as reduces the computing power required when formatting the AI image to a 3D image because there are less pixels to for the 3D image generator to process.

At block 512, the process 500 may include identifying a midline of the second image and at block 514, the process 500 may include generating a third image and a fourth image, wherein the third image includes a first side of the midline and the fourth image includes a second side of the midline. For example, the 3D modeling component 168 may divide the image subject 402 into two separate images. In some cases, the 3D modeling component 168 may identify a vertical midline 404 depending on a context of the image subject 402. By way of example, the 3D modeling component 168 may identify hands and/or fingers of the image subject 402 and place the vertical midline 404 over the image subject 402 to avoid slicing directly over the hands and/or fingers of the image subject 402, as these can be difficult both for a human or machine to understand what that image represents, in the output of one of the individual images (e.g., a single finger or hand that is unattached to a body and is “floating” in the image). Generating the a slice 406 and a slice 408 results in an improved 3D model output because the context of the 2D images are more readily understandable by the 3D modeling component 168, which may include a 3D model generator, (as opposed to if the image was sliced via a horizontal midline and a first image included 4 legs and a stomach and the second image include a tail, a head, and top half of the dog). In some cases, the 3D modeling component 168 may automatically determine a direction to generate a midline (e.g., horizontal, vertical, diagonal, etc.) as well as a placement of the midline (e.g., dividing the image exactly in half 50% on top or left and 50% on bottom or right). For instance, the 3D modeling component 168 may dynamically determine a placement of the midline such that the 3D modeling component 168 may generate a 3D model output of the image subject in a highest quality and most efficient manner based on an anatomy of the image subject in question.

At block 516, the process 500 may include generating a first 3D model based at least in part on the third image and at block 518, the process 500 may include generating a second 3D model based at least in part on the fourth image. For example, once the image subject 402 (also referred to as the AI image or the 2D image) has been generated and divided into the slice 406 and the slice 408, the 3D modeling component 168 may generate a 3D model 410 representing the slice 406 and a 3D model 412 representing the slice 408.

At block 520, the process 500 may include generating a third 3D model by combining the first 3D model and the second 3D model. For example, the 3D modeling component 168 may combine the 3D model 410 and the 3D model 412 and generate a combined 3D model 414 representing subject 402 (e.g., the image subject of the AI image and/or the 2D image). The 3D model 414 may be generated in a 3D printable format, such as .STL. In some cases, the 3D model 414 may be post-processed and fine-tuned for quality purposes. In some examples, the 3D modeling component 168 may send the 3D model 414 to third-party marketplace system 124 (which may include a 3D printing marketplace) for printing, painting, and/or fulfillment.

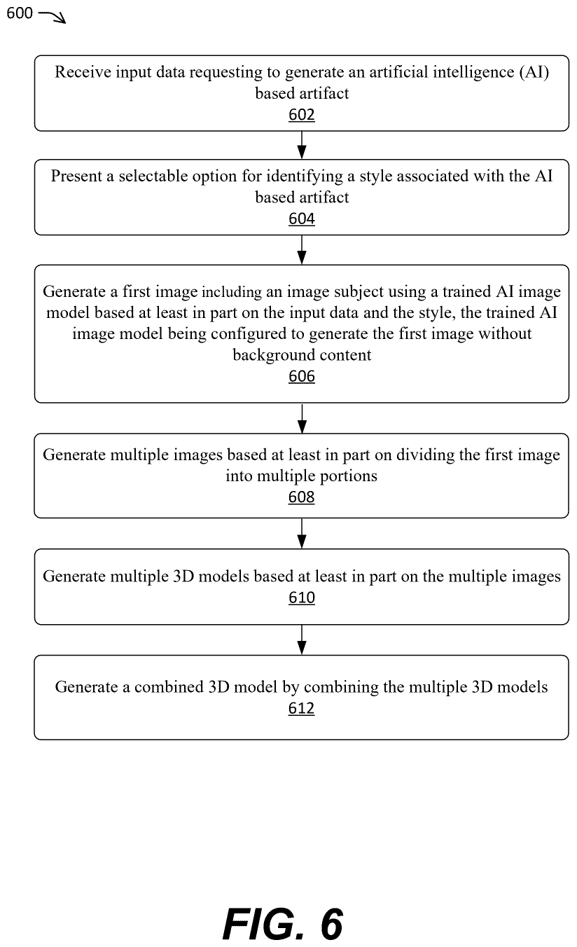

FIG. 6 illustrates a process 600 for artifact registration and management. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIG. 6, although the processes may be implemented in a wide variety of other environments, architectures and systems.

FIG. 6 illustrates a flow diagram of an example process 600 for generating a 3D model. The process 600 may be implemented by the market system, 104, the electronic device, and/or a combination thereof.

At block 602, the process 600 may include receiving input data requesting to generate an artificial intelligence (AI) based artifact. For example, the user input may include text describing an image representing a character from a game (e.g., facial features, character sex, clothing, etc.).

At block 604, the process 600 may include presenting a selectable option for identifying a style associated with the AI based artifact. For example, the user interface 200 may be presented to a user and may enable users to select from one or more of the artist model 202, artist model 204, artist model 206, artist model 208, artist model 210, artist model 212, and artist model 214, which may include generative AI image generation models trained on art from one particular artist. For instance, underneath each of the artist model 202, artist model 204, artist model 206, artist model 208, artist model 210, artist model 212, and artist model 214 may be an artist identifier, such as “Artist A,” “Artist B,” “Artist C,” “Artist D,” “Artist E,” “Artist F,” “Artist G.” This may enable users to maintain a consistent style among images and physical objects (e.g., character miniatures) they intend to generate. In some case, the user interface 200 may include a selectable portion 216 that, when selected, may enable a user to provide user input via a text box 218, such as a prompt to be used when generation an AI artifact. For example, the user input may include text describing an image representing a character from a game (e.g., facial features, character sex, clothing, etc.). In some cases, the user input may include a selection of a particular artists style to be used when generating the image. For example, as illustrated in the user interface 200, multiple versions of an image subject each depicting the image subject in an artist version associated with each individual artist.

At block 606, the process 600 may include generating a first image including an image subject using a trained AI image model based at least in part on the input data and the style, the trained AI image model being configured to generate the first image without background content. For example, the AI component 167 may be configured to generate an image 302 including an image subject 304 via the AI component 167 to generate image subject 306 with the background 308 of the image 302 removed. In some cases, the image subject 306 may be in the style of the artist model chosen by the user. This enables the AI component 167 to receive input requests from a user for generating the image 302 (e.g., an image of a character) and to generate the image subject 306 both in the style of the artist and also without the background 308. Generating images with no background improves the quality of the 3D image output as well as reduces the computing power required when formatting the AI image to a 3D image because there are less color pixels to for the 3D image generator to process.

At block 608, the process 600 may include generating multiple images based at least in part on dividing the first image into multiple portions. For example, the AI component 167 may remove pixel space around the image subject, so that the image subject is as large as possible in the image. For example, the AI component 167 may identify one or more pixels surrounding the image subject and remove the pixel space in which these pixels are located. Removing these pixels and/or the pixel space increases the percentage of area in which the image subject is presented in the image. Removing the unnecessary pixels and/or pixels spaces improves the quality of the 3D image output as well as reduces the computing power required when formatting the AI image to a 3D image because there are less pixels to for the 3D image generator to process.

At block 610, the process 600 may include generating multiple 3D models based at least in part on the multiple images. For example, the 3D modeling component 168 may divide the image subject 402 into two separate images. In some cases, the 3D modeling component 168 may identify a vertical midline 404 depending on a context of the image subject 402. By way of example, the 3D modeling component 168 may identify hands and/or fingers of the image subject 402 and place the vertical midline 404 over the image subject 402 to avoid slicing directly over the hands and/or fingers of the image subject 402, as these can be difficult both for a human or machine to understand what that image represents, in the output of one of the individual images (e.g., a single finger or hand that is unattached to a body and is “floating” in the image). Generating the a slice 406 and a slice 408 results in an improved 3D model output because the context of the 2D images are more readily understandable by the 3D modeling component 168, which may include a 3D model generator, (as opposed to if the image was sliced via a horizontal midline and a first image included 4 legs and a stomach and the second image include a tail, a head, and top half of the dog). In some cases, the 3D modeling component 168 may automatically determine a direction to generate a midline (e.g., horizontal, vertical, diagonal, etc.) as well as a placement of the midline (e.g., dividing the image exactly in half 50% on top or left and 50% on bottom or right). For instance, the 3D modeling component 168 may dynamically determine a placement of the midline such that the 3D modeling component 168 may generate a 3D model output of the image subject in a highest quality and most efficient manner based on an anatomy of the image subject in question.

At block 612, the process 600 may include generating a combined 3D model by combining the multiple 3D models. For example, once the image subject 402 (also referred to as the AI image or the 2D image) has been generated and divided into the slice 406 and the slice 408, the 3D modeling component 168 may generate a 3D model 410 representing the slice 406 and a 3D model 412 representing the slice 408. In some cases, the 3D modeling component 168 may combine the 3D model 410 and the 3D model 412 and generate a combined 3D model 414 representing subject 402 (e.g., the image subject of the AI image and/or the 2D image). The 3D model 414 may be generated in a 3D printable format, such as .STL. In some cases, the 3D model 414 may be post-processed and fine-tuned for quality purposes. In some examples, the 3D modeling component 168 may send the 3D model 414 to third-party marketplace system 124 (which may include a 3D printing marketplace) for printing, painting, and/or fulfillment.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A system comprising:
one or more processors; and
non-transitory computer-readable media storing computer-executable instructions that, when executed by the one or more processors, cause the one or more processors to perform operations comprising:
receiving, from an electronic device, input data requesting to generate an artificial intelligence (AI) based artifact;
presenting a selectable option for identifying a style associated with the AI based artifact;
generating a first image including an image subject using a trained AI image model based at least in part on the input data and the style, the trained AI image model being configured to generate the first image without background content;
identifying at least one or more pixels surrounding the image subject;
generating a second image by removing the one or more pixels such that the image subject composes an area of the second image that is larger than in the first image;
identifying a midline of the second image;
generating a third image and a fourth image, wherein the third image includes a first side of the midline and the fourth image includes a second side of the midline;
generating a first 3D model based at least in part on the third image;
generating a second 3D model based at least in part on the fourth image; and
generating a third 3D model by combining the first 3D model and the second 3D model.

2. The system of claim 1, the operations further comprising sending the third 3D model in an .STL 3D printable format to a third-party 3D printer.

3. The system of claim 1, wherein the style is one of multiple styles that are each associated with a respective artist and are selectable to be used in association with generating the first image.

4. The system of claim 1, wherein the trained AI image model includes a dyLoRA model.

5. The system of claim 1, the operations further comprising generating the trained AI image model by providing the trained AI image model with one or more images of a subject and a white background.

6. The system of claim 1, wherein identifying the midline of the second image includes at least one of identifying a vertical midline or identifying a horizontal midline.

7. The system of claim 6, the operations further comprising determining to utilize the vertical midline or the horizontal midline based at least in part on an improvement to at least one of the first 3D model, the second 3D model, or the third 3D model.

8. A method, comprising:
receiving, from an electronic device, input data requesting to generate an artificial intelligence (AI) based artifact;
presenting a selectable option for identifying a style associated with the AI based artifact;
generating a first image including an image subject using a trained AI image model based at least in part on the input data and the style, the trained AI image model being configured to generate the first image without background content;
identifying at one or more pixels surrounding the image subject;
generating a second image by removing the one or more pixels such that the image subject composes an area of the second image that is larger than in the first image;
identifying a midline of the second image;
generating a third image and a fourth image, wherein the third image includes a first side of the midline and the fourth image includes a second side of the midline;
generating a first 3D model based at least in part on the third image;
generating a second 3D model based at least in part on the fourth image; and
generating a third 3D model by combining the first 3D model and the second 3D model

9. The method of claim 8, further comprising sending the third 3D model in an .STL 3D printable format to a third-party 3D printer.

10. The method of claim 8, wherein the style is one of multiple styles that are each associated with a respective artist and are selectable to be used in association with generating the first image.

11. The method of claim 8, wherein the trained AI image model includes a dyLoRA model.

12. The method of claim 8, further comprising generating the trained AI image model by providing the trained AI image model with one or more images of a subject and a white background.

13. The method of claim 8, wherein identifying the midline of the second image includes at least one of identifying a vertical midline or identifying a horizontal midline.

14. The method of claim 13, further comprising determining to utilize the vertical midline or the horizontal midline based at least in part on an improvement to at least one of the first 3D model, the second 3D model, or the third 3D model.

15. A method, comprising:
receiving input data requesting to generate an artificial intelligence (AI) based artifact;
presenting a selectable option for identifying a style associated with the AI based artifact;
generating a first image including an image subject using a trained AI image model based at least in part on the input data and the style, the trained AI image model being configured to generate the first image without background content;
generating multiple images based at least in part on dividing the first image into multiple portions;
generating multiple 3D models based at least in part on the multiple images; and
generating a combined 3D model by combining the multiple 3D models.

16. The method of claim 15, further comprising sending the combined 3D model in an .STL 3D printable format to a third-party 3D printer.

17. The method of claim 15, wherein the style is one of multiple styles that are each associated with a respective artist and are selectable to be used in association with generating the first image.

18. The method of claim 15, wherein the trained AI image model includes a dyLoRA model.

19. The method of claim 15, further comprising generating the trained AI image model by providing the trained AI image model with one or more images of a subject and a white background.

20. The method of claim 15, further comprising identifying a midline of the first image by identifying a vertical midline or identifying a horizontal midline.
